(19) United States
(12) Patent Application Publication
(10) Pub. No.: US 2021/0240821 A1
(43) Pub. Date: Aug. 5, 2021

(54) SENSING SYSTEM AND SENSING METHOD

(71) Applicant: NIPPON TELEGRAPH AND TELEPHONE CORPORATION, Tokyo (JP)

(72) Inventors: Manami ITO, Musashino-shi, Tokyo (JP); Kenichiro MUTO, Musashino-shi, Tokyo (JP); Kimihiro YAMAKOSHI, Musashino-shi, Tokyo (JP)

(73) Assignee: NIPPON TELEGRAPH AND TELEPHONE CORPORATION, Tokyo (JP)

(21) Appl. No.: 17/049,030

(22) PCT Filed: Apr. 22, 2019
(86) PCT No.: PCT/JP2019/017095

§ 371 Date: Oct. 20, 2020

(30) Foreign Application Priority Data
Apr. 24, 2018 (JP) 2018-083355

(51) Int. Cl. G06F 21/55; G01B 11/00; B25J 13/08

(52) U.S. Cl. CPC G06F 21/552; G06F 2221/034; B25J 13/08; G01B 11/002

(57) ABSTRACT

In a detection system (1) including a sensor (2) and a controller (3), an acquisition unit (2a) in the sensor (2) acquires sensor data, a calculation unit (2b) calculates, by using the sensor data, a MAC value from which non-tampering of the sensor data is verifiable, and a transmission unit (2d) transmits the sensor data to the controller (3) or transmits the MAC value to the controller (3) in place of the sensor data when the calculation unit (2b) has calculated the MAC value. In the controller (3), a reception unit (3a) receives the sensor data or the MAC value transmitted from the sensor (2), and when the reception unit (3a) has received the MAC value, a verification unit (3b) verifies the MAC value by using the sensor data last received by the reception unit (3a).

### TECHNICAL FIELD

The present invention relates to a detection system and a detection method.

### BACKGROUND ART

In recent years, there has been an increase of cases in which a network is used in a control system such as a robot arm that performs control using sensor data. Accordingly, the risk of cyber-attacks in which sensor data is tampered with has increased. Because a tampering attack on sensor data leads to serious damage due to a runaway control system, countermeasures are required.

In related art, a technology for imparting a Message Authentication Code (MAC) value or an electronic signature to transmission data in order to detect tampering with sensor data is known (see NPLs 1 and 2). In this technology, a data sender imparts information, which is generated by using a common key shared with a receiver, to the data, and the receiver verifies the imparted information. Thereby, spoofing and data replacement by unintended third parties can be detected.

Further, a technology for encrypting sensor data to detect tampering of the sensor data is also known. In this technology, ciphertext obtained by encrypting sensor data with a common key is exchanged. Because a third party who does not have the common key cannot generate ciphertext of an intended value through decryption, the third party can only perform an attack of randomly tampering with ciphertext. Because the sensor data is often corrupted when the ciphertext that has been randomly tampered with is decrypted, a mechanism that detects the corrupted sensor data can be provided to detect tampering of the sensor data.

### CITATION LIST

### Non Patent Literature

NPL 1: H. Krawczyk, M. Bellare, R. Canetti, “HMAC: Keyed-Hashing for Message Authentication,” IETF RFC 2104, February 1997

NPL 2: Dennis K. Nilsson, Ulf E. Larson, Erland Jonsson, “Efficient In-Vehicle Delayed Data Authentication Based on Compound Message Authentication Codes,” Vehicular Technology Conference, 2008

### SUMMARY OF THE INVENTION

### Technical Problem

However, there has been a problem in that in order to detect tampering of the sensor data by using the related art, the amount of communication data has increased and performance deterioration of a control system has become inevitable. For example, in a scheme for imparting a MAC value or a digital signature, an increase in the amount of communication data is inevitable. Further, a scheme for encrypting sensor data is vulnerable to a replay attack in which an attacker wiretaps and stores ciphertext in advance and then replaces ciphertext being exchanged at a present time between a sensor and a controller with the past ciphertext. For countermeasures against a replay attack, imparting information such as a counter is required, and an increase in the amount of communication data is also inevitable.

On the other hand, in a control system that performs remote control with sensor data, real time response is required, and a reduction in payload becomes more necessary as a delay due to impartment of error correction becomes more problematic, for example. It is known that an increase in an amount of communication data affects a communication delay between a sensor and a controller, a sampling frequency indicating the number of transmissions and receptions of the sensor data per unit time, and control performance of a control system.

That is, a control system is evaluated as having high control performance when a value of an index obtained by summing shaking generated until a target is reached and energy used is small. Here, when the amount of communication data increases and a communication delay occurs or a sampling frequency decreases, precise control of the control system becomes difficult and control performance is degraded.

The present invention has been made in view of the foregoing, and an object of the present invention is to suppress deterioration of performance of a control system and detect tampering of sensor data.

### Means for Solving the Problem

In order to solve the problem described above and achieve the object, a detection system according to the present invention is a detection system comprising a sensor and a controller, wherein the sensor includes an acquisition unit configured to acquire sensor data; a calculation unit configured to calculate tampering detection information from which non-tampering of the sensor data is verifiable, by using the sensor data; and a transmission unit configured to transmit the sensor data to the controller or transmit the tampering detection information to the controller in place of the sensor data when the calculation unit has calculated the tampering detection information, and the controller includes a reception unit configured to receive the sensor data or the tampering detection information transmitted from the sensor; and a verification unit configured to verify the tampering detection information by using the sensor data last received by the reception unit when the reception unit has received the tampering detection information.

### Effects of the Invention

According to the present invention, it is possible to suppress deterioration of performance of a control system and detect tampering of sensor data.

### BRIEF DESCRIPTION OF DRAWINGS

FIG. 1 is a schematic diagram illustrating a schematic configuration of a detection system according to the present embodiment.

FIG. 2 is an illustrative diagram illustrating a process of the detection system.

FIG. 3 is an illustrative diagram illustrating a process of the detection system.

FIG. 4 is an illustrative diagram illustrating a process of a verification unit.

FIG. 5 is a sequence diagram illustrating a detection processing procedure in the detection system according to the embodiment.

FIG. 6 is a diagram illustrating an example of a computer that executes a detection program.

### DESCRIPTION OF EMBODIMENTS

Hereinafter, an embodiment of the present invention will be described in detail with reference to drawings. Note that the present invention is not limited by the embodiment. Also, the same components in description of the drawings will be represented with the same reference signs.

### Configuration of Detection System

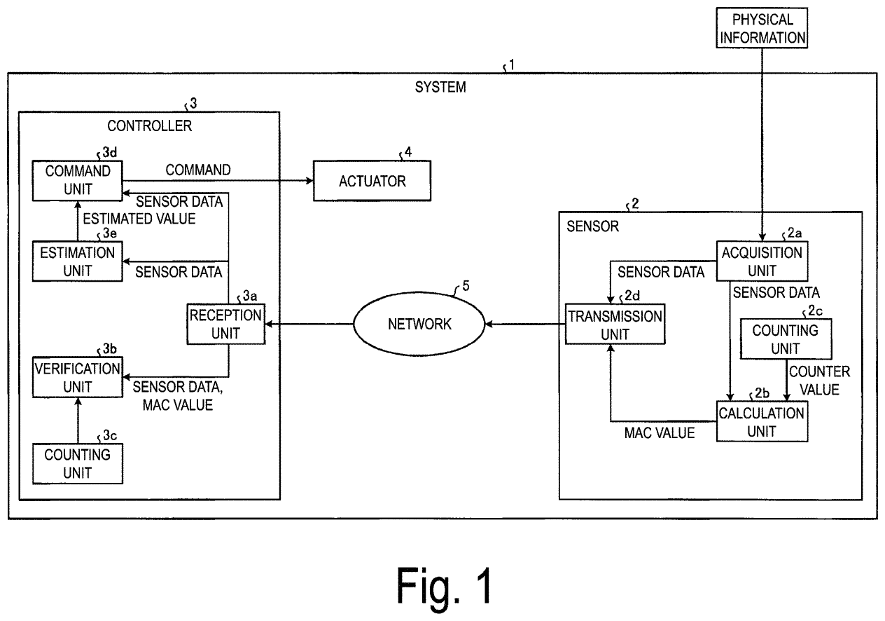

FIG. 1 is a schematic diagram illustrating a schematic configuration of a detection system according to the present embodiment. The detection system 1 is, for example, a control system of a robot arm or the like, and includes a sensor 2, a controller 3, and an actuator 4, as illustrated in FIG. 1.

The sensor 2 is, for example, an external sensor such as a tactile sensor or a visual sensor for controlling a robot arm, and transmits sensor data obtained by sensing external physical information to the controller 3 via a network 5. The controller 3 controls, for example, the actuator 4 such as a robot arm by using the sensor data received from the sensor 2.

In this detection system 1, the sensor 2 transmits a MAC value calculated by using the sensor data up to (N−1) times in place of the sensed sensor data to the controller 3 every predetermined N times. Here, the MAC value is information for authenticating that a person who transmits the sensor data is legitimate and confirming authenticity of the sensor data, that is, that the sensor data has not been tampered with.

When the controller 3 receives the MAC value from the sensor 2, the controller 3 calculates a MAC value by using the sensor data received up to (N−1) times, and compares this MAC value with the MAC value received from the sensor 2 to perform verification. Thereby, the controller 3 authenticates the sensor 2 and detects that the sensor data has not been tampered with. Further, the controller 3 estimates sensor data of an N-th time.

### Configuration of Sensor

The sensor 2 includes a control unit that is realized by a Micro Processing Unit (MPU), a field programmable gate array (FPGA), or the like, and this control unit functions as an acquisition unit 2a, a calculation unit 2b, a counting unit 2c, and a transmission unit 2d, as illustrated in FIG. 1.

Further, the sensor 2 includes a communication control unit (not illustrated) that is realized by a network interface card (NIC) or the like, and this communication control unit controls communication between the control unit and an external device such as the controller 3 via the network 5. The sensor 2 includes a storage unit (not illustrated) that is realized by a semiconductor memory element such as a flash memory.

The acquisition unit 2a acquires the sensor data. Specifically, the acquisition unit 2a senses external physical information, converts the physical information to a digital value, and sets this digital value as the sensor data. Examples of the physical information include information such as pressure indicating a mechanical relationship with a contact object in a tactile sensor, and positional information of a target object in a visual sensor.

The calculation unit 2b calculates tampering detection information from which non-tampering of the sensor data is verifiable, by using the sensor data. Further, the counting unit 2c counts the number of times the tampering detection information has been calculated. The transmission unit 2d transmits the sensor data to the controller 3 or transmits the tampering detection information to the controller 3 in place of the sensor data when the calculation unit 2b has calculated the tampering detection information.

Specifically, the calculation unit 2b calculates the MAC value as the tampering detection information by using the sensor data and the count value obtained by the counting unit 2c and stored in the storage unit. Further, the transmission unit 2d transmits the sensor data acquired by the acquisition unit 2a to the controller 3, and transmits the MAC value calculated by the calculation unit 2b to the controller 3 without transmitting the sensor data every predetermined N times.

For example, the calculation unit 2b calculates the MAC value by using the sensor data of the first to (N−1)-th time and the counter value of the counting unit 2c each time the transmission unit 2d transmits the sensor data to the controller 3 (N−1) times. The sensor data that the calculation unit 2b uses to calculate the MAC value may be some of the sensor data of the first to (N−1)-th time, and may be, for example, only the sensor data of the (N−1)-th time.

This MAC value is calculated by using a common key that is shared by the sensor 2 and the controller 3. Further, when the calculation unit 2b has calculated the MAC value, the counting unit 2c updates the counter value in the storage unit.

When the transmission unit 2d transmits the sensor data or the MAC value of a T-th time, the calculation unit 2b calculates, at T=kN (k=1, 2, . . . ), the MAC value by using the sensor data at T=kN−1 and a current counter value.

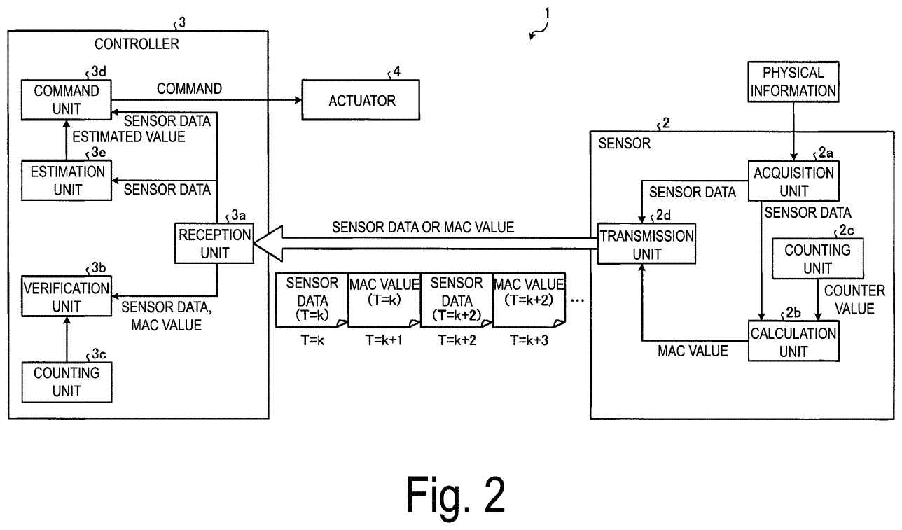

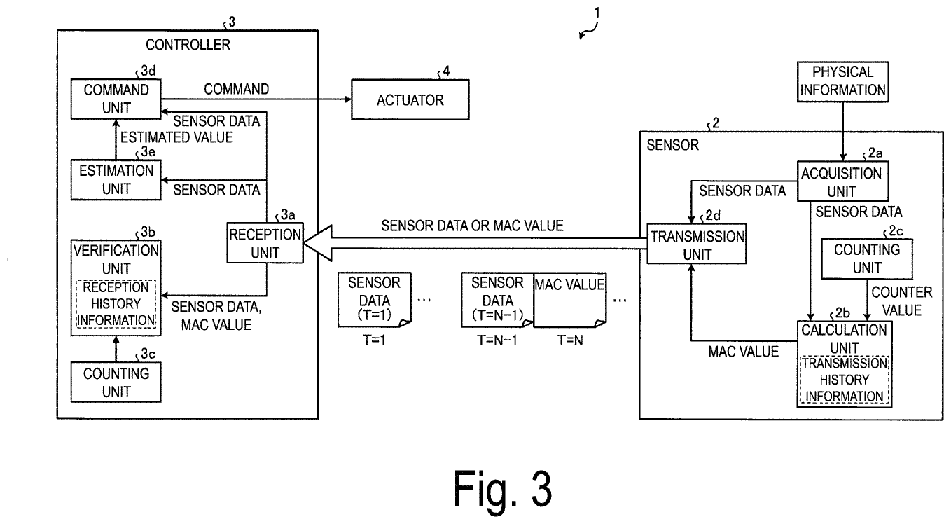

Here, FIG. 2 and FIG. 3 are illustrative diagrams illustrating a process of the detection system 1. FIG. 2 illustrates a process (N=2) of the detection system 1 in this case. In the example illustrated in FIG. 2, the transmission unit 2d transmits the sensor data (T=k) to the controller 3 at T=k and the sensor data (T=k+2) to the controller 3 at T=k+2.

Further, the transmission unit 2d transmits the MAC value (T=k) calculated by using the sensor data (T=k) to the controller 3 without transmitting the sensor data (T=k+1) at T=k+1. Similarly, the transmission unit 2d transmits the MAC value (T=k+2) calculated by using the sensor data (T=k+2) to the controller 3 without transmitting the sensor data (T=k+3) at T=k+3.

Alternatively, the calculation unit 2b may calculate the MAC value by using a history of the transmission of the sensor data in the transmission unit 2d and the sensor data, and set the MAC value as the tampering detection information. FIG. 3 illustrates a process (N>2) of the detection system 1 in this case.

For example, transmission history information (T) indicating a history of the transmission of the sensor data or the MAC value of a T-th time is a value calculated by using Formula (1) below in which a predetermined hash function is used. When the transmission unit 2d has transmitted the sensor data or the MAC value, the calculation unit 2b calculates the transmission history information (T), and updates transmission history information (T−1) in the storage unit with the transmission history information (T).

Transmission history information (T)=Hash (sensor data (T), transmission history information (T−1)) (1)

The calculation unit 2b calculates the MAC value by using the transmission history information (T−1) and the current counter value, at T=N. Further, when the calculation unit 2b has calculated the MAC value, the counting unit 2c updates the counter value in the storage unit.

In the example illustrated in FIG. 3, the transmission unit 2d transmits the sensor data (T=1) to the controller 3 at T=1, . . . , and the sensor data (T=N−1) to the controller 3 at T=N−1. The transmission unit 2d transmits the MAC value calculated by using the transmission history information (T−1) and the counter value to the controller 3 at T=N.

Similarly, the transmission unit 2d transmits the sensor data (T) to the controller 3 at T kN (k=1, 2, . . . ). Further, the transmission unit 2d transmits the MAC value calculated by using the transmission history information (T−1) and the counter value to the controller 3 at T=kN.

The detection system 1 may perform the process illustrated in FIG. 3 even when N=2.

### Configuration of Controller

Description will return to FIG. 1. The controller 3 is realized by, for example, a general-purpose computer such as a personal computer, and a control unit realized by a Central Processing Unit (CPU) or the like functions as a reception unit 3a, a verification unit 3b, a counting unit 3c, a command unit 3d, and an estimation unit 3e, as illustrated in FIG. 1.

Further, the controller 3 includes a communication control unit (not illustrated) that is realized by an NIC or the like, and the communication control unit controls communication of the control unit with an external device such as the sensor 2 via the network 5. Further, the controller 3 includes a storage unit (not illustrated) that is realized by a semiconductor memory device such as a RAM or a flash memory or a storage device such as a hard disk or an optical disc.

The reception unit 3a receives the sensor data or tampering detection information transmitted from the sensor 2. Specifically, the reception unit 3a receives the sensor data from the sensor 2 at T=1 to (N−1), and receives the MAC value from the sensor 2 at T=N. Similarly, the reception unit 3a receives the sensor data from the sensor 2 at T≠kN (k=1, 2, . . . ), and receives the MAC value from the sensor 2 at T=kN.

When the reception unit 3a has received the tampering detection information, the verification unit 3b verifies the tampering detection information by using the sensor data last received by the reception unit 3a. Further, the counting unit 3c counts the number of times the tampering detection information has been verified.

Specifically, when the MAC value has been received from the sensor 2 at T=kN, the verification unit 3b calculates the MAC value by using the sensor data received from the sensor 2 at T=(k−1)N+1 to kN−1 and the counter value obtained by the counting unit 3c and stored in the storage unit. Further, the verification unit 3b compares the calculated MAC value with the MAC value received from the sensor 2 to perform verification. Further, when the verification unit 3b has calculated the MAC value, the counting unit 3c updates the counter value in the storage unit.

For example, in the example illustrated in FIG. 2, the verification unit 3b calculates the MAC value by using the sensor data at T=kN−1, the current counter value, and the common key that is shared by the sensor 2 and the controller 3 in T=kN (N=2, k=1, 2, . . . ), similar to the calculation unit 2b. Further, the verification unit 3b compares the calculated MAC value with the MAC value received from the sensor 2 to perform verification.

When the MAC values match each other, the verification unit 3b authenticates the sensor 2 as legitimate and determines that the sensor data has not been tampered with. On the other hand, when the MAC values do not match each other, the verification unit 3b determines that tampering of the sensor data has been detected. In this case, a notification is performed, for example, by outputting an error message to an output unit such as a display (not illustrated) included in the controller 3 or an external device such as a management server.

Further, in the example illustrated in FIG. 3, the verification unit 3b verifies the MAC value by using a history of the reception of the sensor data by the reception unit 3a and the sensor data. Specifically, reception history information (T) indicating the history of the reception of the sensor data or the MAC value at the T-th time is a value that is calculated by using Formula (2) below in which a predetermined hash function is used, similar to Formula (1) above. When the reception unit 3a has received the sensor data or the MAC value, the verification unit 3b calculates the reception history information (T), and updates the reception history information (T−1) in the storage unit with reception history information (T).

Reception history information (T)=Hash (sensor data (T), reception history information (T−1)) (2)

The verification unit 3b calculates the MAC value by using the reception history information (T−1) and the current counter value at T=N. Further, when the verification unit 3b has calculated the MAC value, the counting unit 3c updates the counter value in the storage unit.

Further, the verification unit 3b compares the calculated MAC value with the MAC value received from the sensor 2 to perform verification. When the MAC values match each other, the verification unit 3b authenticates that the sensor 2 is legitimate and determines that the sensor data has not been tampered with, as described above. On the other hand, when the MAC values do not match each other, the verification unit 3b determines that tampering of the sensor data has been detected.

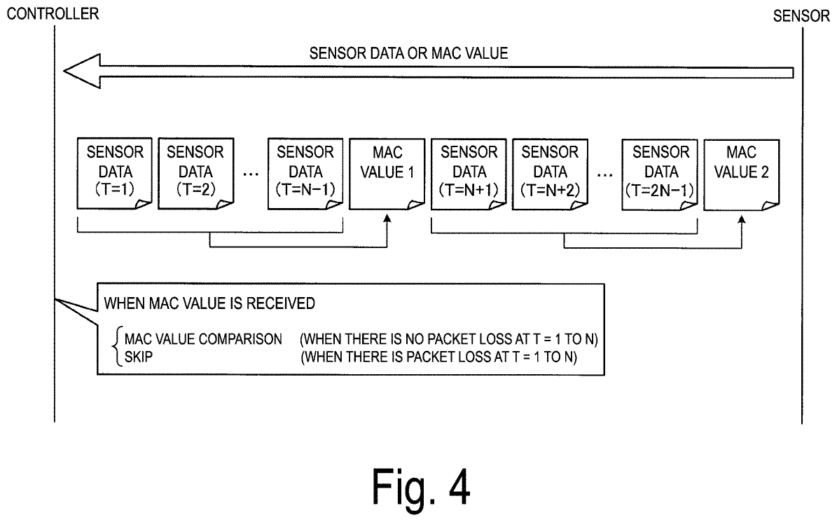

Here, FIG. 4 is an illustrative diagram illustrating a process of the verification unit 3b. As illustrated in FIG. 4, the verification unit 3b compares the calculated MAC value with the MAC value received from the sensor 2 to perform verification only when there is no packet loss at T=(k−1)N+1 to kN−1. When there is packet loss at T=(k−1)N+1 to kN−1, the verification unit 3b skips a process of the comparison and verification.

In the example illustrated in FIG. 4, when there is no packet loss at T=1 to N−1, the verification unit 3b compares the MAC value 1 received at T=N with the calculated MAC value to perform verification. When there is no packet loss at T=N+1 to 2N−1, the verification unit 3b compares a MAC value 2 received at T=2N with the calculated MAC value to perform verification.

FIG. 4 illustrates a case in which a MAC value in which the sensor data at T=(k−1)N+1 to kN−1 is reflected has been calculated using the scheme illustrated in FIG. 3, for example.

Description will return to FIG. 1. When the reception unit 3a has received the sensor data, the command unit 3d calculates a command with respect to the actuator 4 by using the sensor data. The command unit 3d transmits the calculated command to the actuator 4. This allows the actuator 4 to be controlled on the basis of sensor data.

When the reception unit 3a has received the MAC value, the estimation unit 3e estimates the sensor data by using the sensor data last received by the reception unit 3a and the command calculated by the command unit 3d by using the sensor data.

Specifically, the estimation unit 3e estimates the sensor data (T=kN) by using the sensor data (T=kN−1) and the command calculated by using this sensor data (T=kN−1), and notifies the command unit 3d of the sensor data (T=kN).

Similarly, the estimation unit 3e estimates the packet when there is packet loss. Specifically, when there is packet loss of the sensor data, the estimation unit 3e estimates the sensor data by using the sensor data last received by the reception unit 3a and the command calculated by the command unit 3d by using the sensor data. Further, when there is packet loss of the MAC value, the estimation unit 3e does not perform the comparison and verification of the MAC values, and performs only the estimation of the sensor data.

The estimation unit 3e notifies the command unit 3d of the estimated sensor data. The command unit 3d calculates a command with respect to the actuator 4 by using the estimated sensor data and transmits the command to the actuator 4. This allows the sensor data to be supplemented, and control delay or degradation of control performance of the actuator 4 based on the sensor data to be suppressed.

A scheme for estimating and supplementing the sensor data is not limited to the above, and for example, the sensor data of the N-th time may be determined according to a predetermined rule.

### Sensing Process

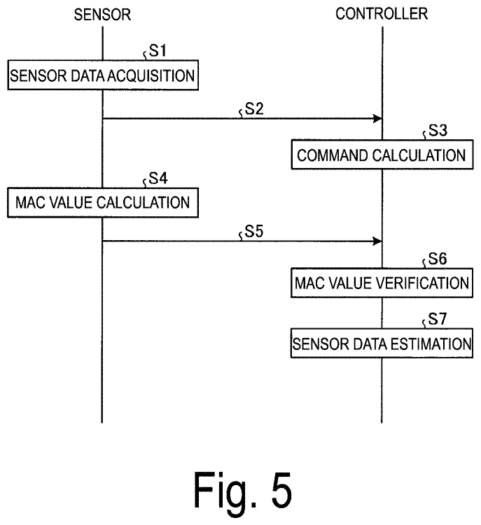

FIG. 5 is a sequence diagram illustrating a detection process procedure in the detection system 1 according to the embodiment. The sequence in FIG. 5 is started at a timing at which an operation of instructing start is input, for example.

First, the acquisition unit 2a of the sensor 2 performs sensing of the physical information, converts the physical information to a digital value, and acquires the sensor data (step S1). Further, the transmission unit 2d transmits the acquired sensor data to the controller 3 (step S2).

In the controller 3, the command unit 3d calculates a command with respect to the actuator 4 by using the sensor data received by the reception unit 3a (step S3) and transmits the command to the actuator 4. Thereby, the actuator 4 is controlled by using the sensor data.

In the sensor 2, the transmission unit 2d transmits the MAC value calculated by the calculation unit 2b in place of the sensor data to the controller 3 at every predetermined N times (steps S4 to S5). For example, the calculation unit 2b calculates the MAC value by using the sensor data transmitted at the (N−1)-th time, the count value of the number of calculations of the MAC values, and the common key. Alternatively, the calculation unit 2b calculates the MAC value by using a hash function of the sensor data transmitted up to 1 to (N−1) times.

In the controller 3, when the reception unit 3a has received the MAC value, the verification unit 3b calculates the MAC value by using the last received sensor data in the same manner as in the calculation unit 2b of the sensor 2, and compares the calculated MAC value with the received MAC value to perform verification (step S6).

When the MAC values match each other, the verification unit 3b authenticates the sensor 2 as legitimate and determines that the sensor data has not been tampered with. When both do not match, the verification unit 3b determines that tampering of the sensor data has been detected and outputs an error message, for example.

Further, in the controller 3, when the reception unit 3a has received the MAC value in place of the sensor data or when a packet loss occurs, the estimation unit 3e estimates the sensor data by using the last received sensor data and the command calculated from the sensor data (step S7). Further, the estimation unit 3e notifies the command unit 3d of the estimated sensor data.

The command unit 3d calculates a command with respect to the actuator 4 by using the estimated sensor data and transmits the command to the actuator 4. Thereby, a series of detection processes end.

As described above, in the detection system 1 according to the embodiment, the acquisition unit 2a in the sensor 2 acquires the sensor data. The calculation unit 2b calculates the MAC value from which non-tampering of the sensor data is verifiable, by using the sensor data. The transmission unit 2d transmits the sensor data to the controller 3 or transmits the MAC value to the controller 3 in place of the sensor data when the calculation unit 2b has calculated the MAC value. In the controller 3, the reception unit 3a receives the sensor data or MAC value transmitted from the sensor 2. When the reception unit 3a has received the MAC value, the verification unit 3b verifies the MAC value by using the sensor data last received by the reception unit 3a.

Thus, in the detection system 1 according to the embodiment, because the amount of communication data is not increased, it is possible to suppress occurrence of a communication delay or a decrease in sampling frequency. Further, communication protocol is not affected because the MAC value is transmitted in place of the sensor data. Thereby, it is possible to prevent control performance of the control system from deteriorating and to detect that sensor data which has been received from the legitimate sensor 2 is sensor data not tampered with.

The sensor 2 further includes the counting unit 2c that counts the number of times the MAC value has been calculated, and the calculation unit 2b calculates the MAC value by using the sensor data and the number of times counted by the counting unit 2c. In this case, the controller 3 further includes the counting unit 3c that counts the number of times that the MAC value has been verified, and the verification unit 3b verifies the MAC value by using the sensor data last received by the reception unit 3a and the number of times the counting unit 3c counts when the reception unit 3a receives the MAC value. Thereby, the accuracy of verifying the MAC value is improved.

The calculation unit 2b of the sensor 2 calculates the MAC value by using the history of the transmission of the sensor data in the transmission unit 2d and the sensor data. In this case, the verification unit 3b of the controller 3 verifies the MAC value by using the history of the reception of the sensor data by the reception unit 3a and the sensor data. Thereby, the accuracy of verifying the MAC value is improved.

Further, in the controller 3, when the reception unit 3a has received the sensor data, the command unit 3d calculates the command with respect to the actuator 4 by using the sensor data. Further, when the reception unit 3a has received the MAC value, the estimation unit 3e estimates the sensor data by using the sensor data last received by the reception unit 3a and the command calculated by the command unit 3d by using the sensor data. This allows control delay or degradation of control performance of the actuator 4 based on the sensor data to be suppressed.

The predetermined N indicating a frequency at which the MAC value is transmitted and received is determined in advance in consideration of control performance and the security performance of the control system. Because sensor data is often lost when N is small and the controller 3 cannot accurately control the actuator 4, the control performance of the control system deteriorates. On the other hand, when N is great, a delay (a detection delay) to detect tampering is increased, and a room for attack given to the attacker is large, and the security performance is degraded.

Therefore, an upper limit of allowable deterioration of the control performance and an upper limit of an allowable detection delay are set, and a range of values of N is determined. A designer can set N as an upper limit of a range of values and prioritize the control performance, and set N as a lower limit of the range of values and prioritize the detection delay curbing in consideration of which of the control performance and detection delay curbing is prioritized. A degree of importance of the control performance and the detection delay curbing may be weighted and N may be selected from a range of values according to the weight. Thus, in the detection system 1, it is possible to flexibly set N in consideration of the control performance and the security performance.

### Program

A program can be created in which the process that is executed by a creation device 10 according to the embodiment is described in a computer-executable language. As an embodiment, the detection system 1 can be implemented by a detection program executing the detection process being installed as packaged software or online software in a desired computer. For example, an information processing device can be caused to function as the sensor 2 and the controller 3 by the information processing device being caused to execute the detection program. The information processing apparatus described here includes a desktop or laptop personal computer. Further, a mobile communication terminal such as a smart phone, a mobile phone, or a Personal Handyphone System (PHS), or a slate terminal such as a Personal Digital Assistant (PDA), for example, is included in a category of the information processing device. Hereinafter, an example of a computer that executes a detection program for realizing the same functions as those of the sensor 2 and the controller 3 will be described.

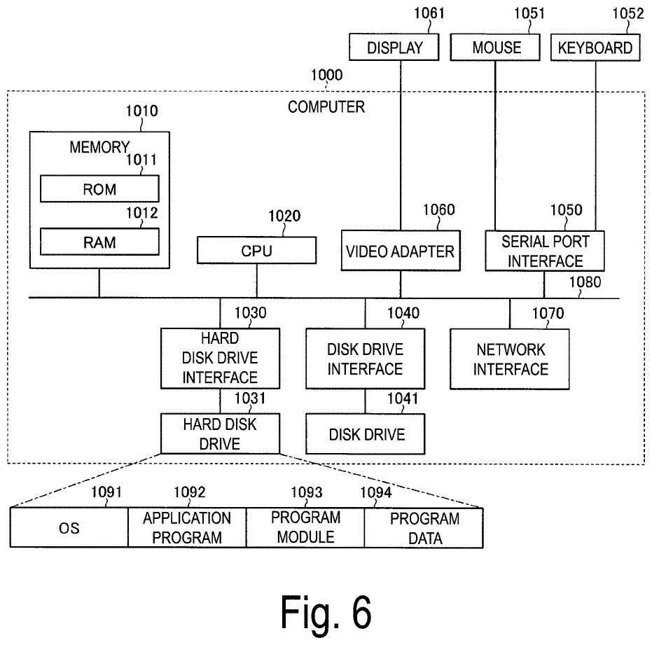

FIG. 6 is a diagram illustrating an example of the computer that executes the detection program. A computer 1000 has, for example, a memory 1010, a CPU 1020, a hard disk drive interface 1030, a disk drive interface 1040, a serial port interface 1050, a video adapter 1060, and a network interface 1070. These units are connected by a bus 1080.

The memory 1010 includes Read Only Memory (ROM) 1011 and a RAM 1012. The ROM 1011 stores a boot program, such as Basic Input Output System (BIOS), for example. The hard disk drive interface 1030 is connected to the hard disk drive 1031. The disk drive interface 1040 is connected to a disk drive 1041. A detachable storage medium such as a magnetic disk or an optical disc, for example, is inserted into the disk drive 1041. A mouse 1051 and a keyboard 1052, for example, are connected to the serial port interface 1050. A display 1061, for example, is connected to the video adapter 1060.

Here, the hard disk drive 1031 stores, for example, an OS 1091, an application program 1092, a program module 1093, and program data 1094. The respective information described in the aforementioned embodiments are stored in, for example, the hard disk drive 1031 and the memory 1010.

Further, the detection program, for example, is stored in the hard disk drive 1031 as the program module 1093 in which commands to be executed by the computer 1000 have been described. Specifically, the program module 1093, in which each of the processes executed by the creation device 10 described in the embodiment is described, is stored in the hard disk drive 1031.

Further, data to be used in information processing according to the detection program is stored, for example, in the hard disk drive 1031 as the program data 1094. Then, the CPU 1020 reads the program module 1093 and the program data 1094 stored in the hard disk drive 1031 as needed in the RAM 1012 and executes the aforementioned respective procedures.

The program module 1093 or the program data 1094 related to the detection program is not limited to being stored in the hard disk drive 1031. For example, the program module 1093 or the program data 1094 may be stored on a detachable storage medium and read by the CPU 1020 via the disc drive 1041 or the like. Alternatively, the program module 1093 or the program data 1094 related to the detection program may be stored in another computer connected via a network such as a Local Area Network (LAN) or a Wide Area Network (WAN) and read by the CPU 1020 via the network interface 1070.

Although the embodiments to which the invention made by the present inventors is applied have been described above, the invention is not limited by the description and the drawings as a part of the disclosure of the present invention based on the embodiments. In other words, all of other embodiments, examples, operation technologies, and the like made by those skilled in the art on the basis of the embodiments are within the scope of the invention.

### REFERENCE SIGNS LIST

1 Detection system
2 Sensor
2a Acquisition unit
2b Calculation unit
2c Counting unit
2d Transmission unit
3 Controller
3a Reception unit
3b Verification unit
3c Counting unit
3d Command unit
3e Estimation unit
4 Actuator
5 Network

1. A detection system comprising a sensor and a controller, wherein the sensor includes
acquisition circuitry configured to acquire sensor data;
calculation circuitry configured to calculate tampering detection information from which non-tampering of the sensor data is verifiable, by using the sensor data; and
a transmitter configured to transmit the sensor data to the controller or transmit the tampering detection information to the controller in place of the sensor data when the calculation circuitry has calculated the tampering detection information, and
the controller includes
a receiver configured to receive the sensor data or the tampering detection information transmitted from the sensor; and
verification circuitry configured to verify the tampering detection information by using the sensor data last received by the receiver when the receiver has received the tampering detection information.

2. The detection system according to claim 1, wherein
the sensor further includes first counting circuitry configured to count a number of times the tampering detection information has been calculated,
the calculation circuitry calculates the tampering detection information by using the sensor data and the number of times counted by the first counting circuitry,
the controller further includes second counting circuitry configured to count a number of times the tampering detection information has been verified, and
the verification circuitry verifies the tampering detection information by using the sensor data last received by the receiver and the number of times counted by the second counting circuitry when the receiver has received the tampering detection information.

3. The detection system according to claim 1, wherein
the calculation circuitry calculates the tampering detection information by using the sensor data and a history of transmission of the sensor data by the transmitter, and
the verification circuitry verifies the tampering detection information by using the sensor data and a history of reception of the sensor data by the receiver.

4. The detection system according to claim 1, wherein
the controller further includes
command circuitry configured to calculate a command with respect to an actuator by using the sensor data when the receiver has received the sensor data; and
estimation circuitry configured to estimate sensor data by using the sensor data last received by the receiver and the command calculated by the command circuitry by using the sensor data when the receiver has received the tampering detection information.

5. A detection method executed in a detection system including a sensor and a controller, the detection method comprising:
acquiring, by the sensor, sensor data;
calculating, by the sensor, tampering detection information from which non-tampering of the sensor data is verifiable, by using the sensor data;
transmitting, by the sensor, the sensor data to the controller or transmitting the tampering detection information to the controller in place of the sensor data when the tampering detection information has been calculated in the calculating of the tampering detection information;
receiving, by the controller, the sensor data or the tampering detection information transmitted from the sensor; and
verifying, by the controller, the tampering detection information by using the sensor data last received in the receiving of the sensor data when the tampering detection information has been received in the receiving of the sensor data.
